(19) United States
(12) Patent Application Publication
(10) Pub. No.: US 2008/0007884 A1
(43) Pub. Date: Jan. 10, 2008

(54) Protection circuit for an input stage, and respective circuit arrangement

(76) Inventors: Ulrich Gries, Hannover (DE); Ulrich Schreiber, Garbsen (DE)

Correspondence Address: THOMSON LICENSING LLC, Two Independence Way, Suite 200, PRINCETON, NJ, 08540, US

(21) Appl. No.: 11/810,160

(22) Filed: Jun. 5, 2007

(30) Foreign Application Priority Data
Jun. 7, 2006 (DE) 102006026803.2

(51) Int. Cl. H02H 9/04; H02H 7/16

(52) U.S. Cl. 361/56; 361/16

(57) ABSTRACT

The protection circuit comprises a Zener diode which is connected via a diode to a coupling capacitor of an input stage, wherein a capacitor is arranged in parallel to the Zener diode. The capacitor is, for example, a tantalum electrolytic capacitor with a capacitance value which is in the range of the value of the coupling capacitor. The protection circuit can be used, in particular, for the protection of sensitive microphone preamplifiers which are connected, via the coupling capacitor, to a capacitor microphone.

### BACKGROUND OF THE INVENTION

This invention relates to a protection circuit with a Zener diode and a diode being connected to an input stage, and to a circuit arrangement comprising a respective protection circuit. A protection circuit of this type is used, for example, for preamplifiers which have highly-sensitive inputs to protect them from ESD and other discharge voltage pulses, for example, when a capacitor microphone is connected to the input stage.

It is known that microphones, especially capacitor microphones, need an operating voltage, 48 volt for example. For capacitor microphones, this operating voltage is also known as “phantom power”. This operating voltage is isolated via two coupling capacitors from the inputs of the preamplifier. However, to ensure low-frequency rendition to below 20 Hz, the two capacitors must have a relatively high capacitance, 47 microfarad each, for example. Due to this magnitude and the applied voltage, the coupling capacitors accordingly store considerable energy which can be discharged in case of improper handling—for example in case of short-circuiting of the input—via the input of the preamplifier. Its input stage may be destroyed thereby.

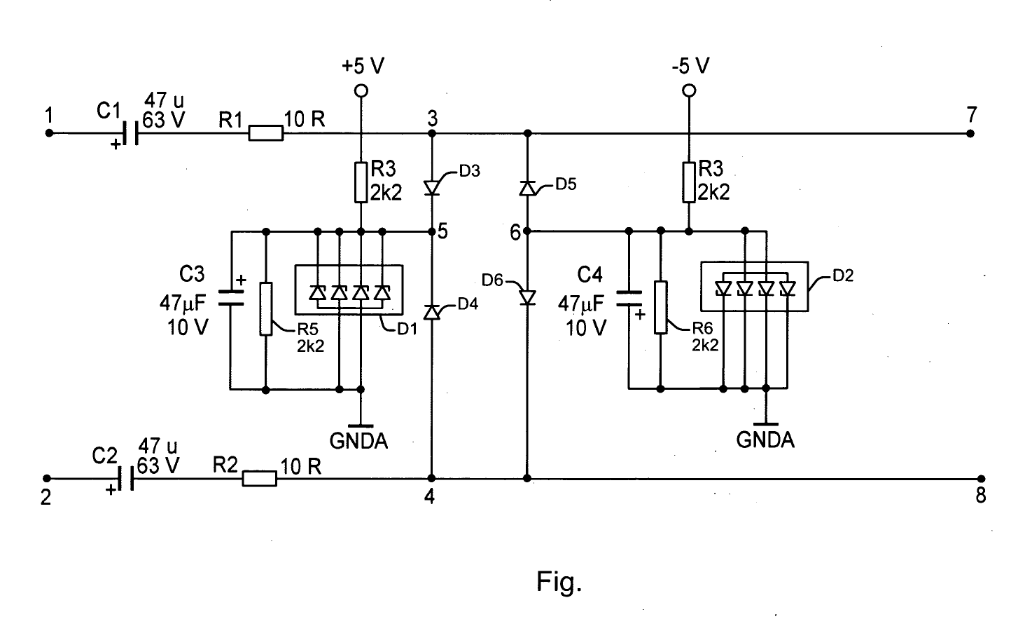

The article by G. K. Hebert and F. W. Thomas: “The 48 Volt Phantom Menace”, Audio Engineering Society, Convention Paper 5335, 110th Convention 2001, May 12-15, Amsterdam, The Netherlands, presented and discussed various protection schemes for microphone preamplifiers. In a preferred exemplary embodiment, FIG. 20, a Schottky diode bridge is used as a protection circuit, comprising two diode pairs in parallel, with two diodes each in parallel, inversely polarized between the two inputs. For discharging positive and negative voltage peaks, a Zener diode is connected to each node between the diode pairs which are biased via separate d.c. voltages. TVS (transient voltage suppression) diodes are used as Zener diodes. Due to the Schottky diode bridge, the Zener diodes are decoupled from the microphone signals so that no capacitive reactions of the TVS diodes to the microphone signals will occur. Schottky diodes and TVS diodes are selected such that, in case of a fault, the voltage at the preamplifier inputs could be reduced to a maximum of 15 volt and the peak flows into the preamplifier inputs to less than 10 milliamperes.

### SUMMARY OF THE INVENTION

The protection circuit according to the invention comprises a Zener diode which is connected via a diode with a terminal of an input stage, wherein a capacitor is provided in parallel with the Zener diode. The Zener diode is, in particular, a Zener diode array specifically suited for overvoltage protection—for example, a TVS Zener diode array—and the capacitor is a tantalum electrolytic capacitor.

The protection circuit can be used, for example, for sensitive microphone preamplifiers which are operated via a coupling capacitor with a capacitor microphone. Microphone preamplifiers of this type must be limited, on the input side, to input signals of smaller or equal 5 volt, depending on the design. Investigations have shown that even a TVS Zener diode array specially designed for overvoltage protection, with four Zener diodes and connected on the input side via a Schottky diode, is possibly not sufficient when a coupling capacitor is accidentally short circuited.

However, the protective effect of this array can be considerably improved through the use of an additional capacitance, especially of a capacitor, parallel to the Zener diode array. The Zener diode array apparently needs a certain amount of time to complete the circuit, and the initial part of the voltage pulse can be intercepted by the capacitor in parallel until the array is enabled. The capacitance value of this capacitor is, for example, in the order of magnitude of the capacitance value of the coupling capacitor on the input side.

In a further aspect of the invention, to the capacitor a resistor is coupled in parallel for suppressing oscillations within the protection circuit. In a preferred embodiment, the resistor acts as a voltage divider together with a second resistor, for keeping the voltage across the capacitor below the threshold voltage of the Zener diode.

### BRIEF DESCRIPTION OF THE DRAWINGS

In the following, a preferred exemplary embodiment of the invention is explained in more detail and by way of example on the basis of a schematic drawing. It is shown:

FIGURE A protection circuit for a symmetric input with two coupling capacitors.

### DETAILED DESCRIPTION OF PREFERRED EMBODIMENTS

The FIGURE shows a circuit arrangement with an input stage, comprising a symmetrical input with connections 1 and 2 as well as coupling capacitors C1, C2. The input stage is connected in series with an integrated preamplifier, not shown, which comprises two connections 7 and 8 on the input side. The preamplifier is, for example, a microphone preamplifier of the type PGA2500, available from Texas Instruments. This IC must be operated with two supply voltages of a maximum of +/−5 volt. The inputs of this preamplifier are sensitive to electrostatic discharges and the input signals must, in particular, not be essentially above or, respectively, below the supply voltages used.

The inputs 7, 8 of the preamplifier are a.c. coupled with the inputs 1 and 2 by the coupling capacitors C1, C2, and the input stage can therefore be connected with a microphone which needs its own supply voltage. Capacitor microphones in particular need a supply voltage of +48 volt. Since microphone preamplifiers are generally required to provide a rendition down to 20 Hz practically without any loss in rendition, the capacitors C1, C2 must have high capacitance values, 47 microfarad for example, since they will act as low-pass filters in the circuit arrangement. Accordingly, the coupling capacitors store relatively high energy when used with a capacitor microphone.

However, when input-side connecting cables are improperly handled, it can happen that one of the inputs 1, 2 is short circuited, for example, relative to ground. The affected coupling capacitor C1 or C2 will thereby be discharged in very short time and flows in ampere range may occur. This will result in interference voltages which destroy the preamplifier, in particular its input stage.

Accordingly, for the protection of the preamplifier, a protection circuit is provided between the coupling capacitors C1, C2 and the inputs 7, 8 of the preamplifier. This protection circuit comprises a diode bridge with two diode pairs, diodes D3-D6, which are connected between two nodes 3 and 4. Each pair of diodes comprises two series-connected, inversely polarized diodes with nodes 5, 6, wherein the diode pair 3, 4 is poled such that positive overvoltage is discharged via node 5, and the diode pair 5, 6 is poled such that negative overvoltage is discharged via node 6. One Zener diode D1, D2 each is connected to nodes 5 or 6, respectively, whose threshold values will determine when diodes D3-D6 are enabled. Diodes D3-D6 are, in particular, fast Schottky diodes. Furthermore, one resistor each R1, R2 with ten ohms is connected between each coupling capacitor C1, C2 from the appropriate connection 7, 8 for limiting the current.

The Zener diode D1 is connected to ground on the anode side and, on the cathode side, biased to a operating positive voltage via a resistor R3. The Zener diode D2 is analogously biased to a negative operating voltage. In this exemplary embodiment, the Zener diodes D1, D2 have a break-through voltage of 3.3 volt so that diodes D3-D6 already conduct at input voltages of approx. +4 or −4 volt, respectively.

In this exemplary embodiment, the Zener diodes D1, D2 are designed as Zener diode arrays. This allows higher flows to be processed or, respectively, higher voltages to be discharged faster. The Zener diode array here is a specific circuit designed as a protection for sensitive inputs against overvoltage—a so-called TVS Zener diode array.

It has been shown, however, that even a Zener diode array with four Zener diodes in parallel is not sufficient, under certain conditions, for an effective protection of the preamplifier. According to the invention, one capacitor C3, C4, in particular a charge capacitor, each is therefore connected in parallel to each Zener diode array D1, D2, in this exemplary embodiment one tantalum electrolytic capacitor each, with 47 microfarad. In this exemplary embodiment, the capacitance value of the capacitors C3, C4 is in the order of magnitude of the capacitance value of the coupling capacitors C1, C2. The protection circuit is thereby able to securely discharge any interference voltage peaks possibly occurring in case of a short circuit at the symmetrical input 1, 2 for a reliable protection of the connected preamplifier.

To each of the capacitors C3, C4 a resistor R5, respectively R6, is coupled in parallel for suppressing oscillations within the protection circuit. In the embodiment shown in the figure, the resistor R5 acts as a voltage divider together with resistor R3, also resistor R6 together with resistor R4, for keeping the voltage across capacitor C3, respectively C4, below the threshold voltage of the Zener diode arrays D1, D2. The resistors R3-R6 have in this embodiment all the same value of 2,2 kilo-Ohms, the voltage dividers providing therefore a voltage of 2,5 Volt across the Zener diode arrays D1, D2, below the breakthrough voltage of 3,3 Volt of the Zener diode arrays D1, D2.

Without the resistors R5, R6, it may happen that oscillations arise between capacitor C3 and Zener diode array D1, respectively capacitor C4 and Zener diode array D2, because capacitor C3 is charged up to about 3,3 Volt via resistor R3, until the Zener diode array D1 conducts. The conduction of the Zener diode array D1 leads to a voltage drop across capacitor C3 until the current through Zener diode D1 is stopped or almost stopped. Subsequently, capacitor C3 is charged again to a higher voltage, until Zener diode array D1 increases conduction again up to a current, which is higher than the current charging capacitor C3. Even a small oscillation of this kind may be coupled to the inputs 7, 8 of the preamplifier, which would lead to a distortion signal for the microphone signals present at inputs 1 and 2. By means of the resistors R5, R6, these oscillations are completely suppressed.

1. Circuit arrangement, comprising an input stage with a coupling capacitor, an amplifier, and a protection circuit arranged between said coupling capacitor and said amplifier, wherein said protection circuit comprises
a Zener diode array, coupled via a diode to said coupling capacitor, and
a charge capacitor arranged in parallel to said Zener diode for providing overvoltage protection.

2. Circuit arrangement according to claim 1, wherein said charge capacitor is an electrolytic capacitor, in particular a tantalum electrolytic capacitor.

3. Circuit arrangement according to claim 2, wherein the capacitance value of said charge capacitor is in the order of magnitude of the capacitance value of said coupling capacitor, in particular in a range of +/−50% of this capacitance value.

4. Circuit arrangement according to claim 1, wherein a resistor is coupled in parallel with said charge capacitor for suppressing oscillations.

5. Circuit arrangement according to claim 4, wherein said resistor acts as a voltage divider together with a second resistor, for keeping the voltage across said charge capacitor below a threshold voltage of said Zener diode array.

6. Circuit arrangement according to claim 1, wherein said input stage comprises a symmetrical input with two connections, on which one coupling capacitor each is provided.

7. Circuit arrangement according to claim 6, comprising a diode bridge with two diode pairs in parallel and inversely polarized diodes which are coupled to nodes after said coupling capacitors, one Zener diode each being coupled to nodes between each pair of said diodes.

8. Circuit arrangement according to claim 1, wherein said Zener diode array is a TVS Zener diode array.

9. Circuit arrangement according to claim 8, wherein said amplifier is a microphone preamplifier.

10. Protection circuit with a Zener diode connected via a diode to an input stage, wherein
a charge capacitor is coupled in parallel with said Zener diode for providing overvoltage protection, and
a resistor is coupled in parallel with said charge capacitor for suppressing oscillations.

11. Protection circuit according to claim 10, wherein said charge capacitor is an electrolytic capacitor, in particular, a tantalum electrolytic capacitor.

12. Protection circuit according to claim 10, wherein said input stage comprises a coupling capacitor.

13. Protection circuit according to claim 12, wherein the capacitance value of said charge capacitor is in the order of magnitude of the capacitance value of said coupling capacitor, in particular in a range of +/−50% of this capacitance value.

14. Protection circuit according to claim 10, wherein said input stage comprises a symmetrical input with two connections, on which one coupling capacitor each is provided.

15. Protection circuit according to claim 14, comprising a diode bridge with two diode pairs in parallel and inversely polarized diodes which are coupled to nodes after the coupling capacitors, one Zener diode each being coupled on nodes between each pair of diodes.

16. Protection circuit according to claim 10, wherein said Zener diode is an overvoltage protection Zener diode array, in particular a TVS Zener diode array.

17. Protection circuit according to claim 10, wherein said resistor acts as a voltage divider together with a second resistor, for keeping the voltage across said charge capacitor below a threshold voltage of said Zener diode.
